(19) United States
(12) Patent Application Publication
(10) Pub. No.: US 2010/0306037 A1
(43) Pub. Date: Dec. 2, 2010

(54) METHOD FOR PROVIDING SHOPPING MALL AND SERVER SYSTEM THEREFORE

(76) Inventor: JEONG GAB LEE, Seoul (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/609,061

(22) Filed: Oct. 30, 2009

(30) Foreign Application Priority Data
May 27, 2009 (KR) 10-2009-0046554

(51) Int. Cl. G06Q 30/00; G06Q 10/00

(52) U.S. Cl. 705/11; 705/14.16; 705/26; 705/30

(57) ABSTRACT

A method for providing a virtual shopping mall is provided. The method includes receiving a request for a multi-party goods sale contest, proceeding with the multi-party goods sale contest when the contest is established in response to the request, analyzing a contest result in consideration of a sale record after a predetermined time lapses or other triggering even occurs, determining a goods sale rank of the plurality of sellers based on the analyzed sale result, and giving different benefits to buyers purchasing goods of the plurality of sellers according to the determined sale rank.

### CROSS-REFERENCE TO RELATED APPLICATION

This application claims the benefit under 35 U.S.C. §119(a) of Korean Patent Application No. 10-2009-0046554, filed on May 27, 2009, which is hereby incorporated by reference in its entirety.

### BACKGROUND

1. Field

The present invention relates to a method for providing a virtual shopping mall, and more particularly, to a method for providing a game-type virtual shopping mall and a server system for providing a virtual shopping mall.

2. Description of the Related Art

Recently, interest in the Internet has increased explosively. Accordingly, besides being a simple subsidiary communication tool, the Internet is evolving into a commercial business space. The development of Internet communications and electronic commerce has given rise to Internet shopping malls.

### BRIEF SUMMARY

The present invention is directed to a method for providing a virtual shopping mall that supports at least one of: (1) a 1:1 (one-on-one) goods sale contest; and (2) a multi-party goods sale contest among at least three sellers. The present invention is also directed to a server system for providing such a virtual shopping mall.

According to an aspect of an embodiment of the present invention, there is provided a method for providing a virtual shopping mall including: receiving a request for a requested goods sale contest; establishing and proceeding with a goods sale contest in response to the request; analyzing a contest result in consideration of a sale record after a predetermined time lapses or other triggering event occurs; determining a winning seller based on the analyzed contest result; and giving benefits to buyers purchasing goods of the winning seller. In an embodiment, the goods sale contest established is different than the requested goods sale contest. For example, the established goods sale contest may include different goods or contestants than those requested. In an embodiment, the method selects, establishes, and proceeds with a goods sale contest independent of any request received.

According to another aspect of an embodiment of the present invention, a method for providing a virtual shopping mall is provided. The method includes receiving a request for a multi-party goods sale contest, establishing and proceeding with a goods sale contest among at least three sellers in response to the request, analyzing a contest result in consideration of a sale record after a predetermined time lapses or other triggering even occurs, determining a goods sale rank of the participating sellers based on the analyzed sale result, and giving different benefits to buyers purchasing goods of the participating sellers according to the determined sale rank. In an embodiment, the goods sale contest established is different than the requested goods sale contest. For example, the established goods sale contest may include different goods or contestants than those requested. In an embodiment, the method selects, establishes, and proceeds with a goods sale contest independent of any request received.

According to yet another aspect of an embodiment of the present invention, there is provided a system for providing a virtual shopping mall, including: a controller for receiving a request for a requested goods sale contest, establishing and proceeding with a goods sale contest in response to the request; analyzing a contest result in consideration of a sale record after a predetermined time lapses or other triggering event occurs, determining a winning seller based on the contest result, and giving benefits to buyers purchasing goods of the winning seller; and a presentation unit for presenting a status of the goods sale contest. In an embodiment, the status of the goods sale contest is presented in real time. In an embodiment, the goods sale contest established is different than the requested goods sale contest. For example, the established goods sale contest may include different goods or contestants than those requested. In an embodiment, the system selects, establishes, and proceeds with a goods sale contest independent of any request received.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain aspects of the invention.

FIG. 1 is a functional block diagram of a system for providing a virtual shopping mall according to an embodiment of the present invention;

FIG. 2 is a functional block diagram of a server for providing a virtual shopping mall according to an embodiment of the present invention;

FIG. 3 is a flowchart of a method for providing a virtual shopping mall according to an embodiment of the present invention;

FIG. 4 schematically illustrates a category-specific goods sale contest according to an embodiment of the present invention;

FIG. 5 illustrates an interface for requesting a goods sale contest according to an embodiment of the present invention;

FIG. 6 illustrates another interface for a requesting a goods sale contest according to an embodiment of the present invention;

FIG. 7 illustrates an interface for providing a 1:1 goods sale contest according to an embodiment of the present invention;

FIG. 8 illustrates an interface for presenting further information about goods for sale according to an embodiment of the present invention;

FIG. 9 illustrates an interface for providing a community in which goods sale information is exchanged according to an embodiment of the present invention;

FIG. 10 illustrates an interface for presenting a result of a goods sale contest according to an embodiment of the present invention;

FIG. 11 illustrates an interface for managing a contest record according to an embodiment of the present invention;

FIG. 12 illustrates an interface for presenting a goods sale contest according to an embodiment of the present invention;

FIG. 13 illustrates an interface for managing a contest record for a particular person according to an embodiment of the present invention;

FIG. 14 illustrates an interface for presenting a 1:1 goods sale contest via a TV home shopping network according to an embodiment of the present invention;

FIG. 15 illustrates an interface for presenting a multi-party goods sale contest via an Internet shopping service according to an embodiment of the present invention; and

FIG. 16 illustrates an interface for presenting a multi-party goods sale contest via a TV home shopping network according to an embodiment of the present invention.

### DETAILED DESCRIPTION

The foregoing and other objects, features, and advantages of the invention are apparent from the following detailed description taken in conjunction with the accompanying drawings

Example embodiments of the present invention will be described with reference to the accompanying drawings. The configuration and operation of the present invention shown in and described with reference to the drawings is for illustration purposes only.

The subject matter of the present invention is described with specificity to meet statutory requirements. But this description is not intended to limit the scope of this patent. Rather, the inventors have contemplated that the claimed subject matter might also be embodied in other ways, to include different steps or combinations of steps similar to those described in this document, in conjunction with other present or future technologies.

Aspects of the invention can be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention can be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

Specific hardware devices, programming languages, components, processes, protocols, formats, and numerous other details including operating environments and the like are set forth to provide a thorough understanding of the present invention. In other instances, structures, devices, and processes are shown in block-diagram form, rather than in detail, to avoid obscuring the present invention. But an ordinary-skilled artisan would understand that the present invention can be practiced without these specific details. Computer systems, servers, work stations, and other machines can be connected to one another across a communication medium including, for example, a network or networks.

As one skilled in the art will appreciate, embodiments of the present invention can be embodied as, among other things: a method, system, or computer-program product. Accordingly, the embodiments can take the form of a hardware embodiment, a software embodiment, or an embodiment combining software and hardware. In one embodiment, the present invention takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to, information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

The invention can be practiced in distributed-computing environments where tasks are performed by remote-processing devices that are linked through a communications network. In a distributed-computing environment, program modules can be located in both local and remote computer-storage media including memory storage devices. The computer-useable instructions form an interface to allow a computer to react according to a source of input. The instructions cooperate with other code segments or modules to initiate a variety of tasks in response to data received in conjunction with the source of the received data.

The present invention can be practiced in a network environment such as a communications network. Such networks are widely used to connect various types of network elements, such as routers, servers, gateways, and so forth. Further, the invention can be practiced in a multi-network environment having various, connected public and/or private networks.

Communication between network elements can be wireless or wireline (wired). As will be appreciated by those skilled in the art, communication networks can take several different forms and can use several different communication protocols. And the present invention is not limited by the forms and communication protocols described herein.

The invention is described more fully hereinafter with reference to the accompanying drawings, in which embodiments of the invention are shown. This invention can, however, be embodied in many different forms and should not be construed as limited to the embodiments set forth herein. Rather, these embodiments are provided to fully enable those of ordinary skill in the art to embody and practice the invention.

Throughout this disclosure, a virtual shopping mall refers to a building-less marketplace for presenting and/or selling goods. Virtual shopping malls can be provided via various media and media devices. For example, a virtual shopping mall can be provided via a television set (TV), Internet Protocol television (IPTV), computer, personal digital assistant (PDA), mobile phone or other device using mobile communication protocols, Internet web browser, Digital Multimedia Presenting (DMB), among other media and media devices. In an embodiment, information for presenting or selling goods is transmitted to a media device for presentation to a user. In an embodiment, purchase information or other feedback is transmitted from the media device or other communications device to a server.

As discussed above, various communication technologies can be used with the subject invention to accomplish the transmission of such information. The subject invention is not limited to any particular communication technology. Communication can be over a network, such as the Internet, a LAN, WAN, VPN. Communication can occur via a mainframe or point-to-point connection. Communication can also occur via various communication protocols known in the art.

A TV is a media device for receiving a broadcast signal from a presenting station, cable network, or other source, demodulating the received broadcast signal, and presenting video and sound information. In an embodiment, a set-top box or other device is used to demodulate the signal from some sources. A TV can include an analog TV using an analog signal and/or a digital TV using a digital signal. In an embodiment, the set top box or other device allows a user of the TV to provide purchase information or other feedback to a server. In an embodiment, the user uses another communication device, such as a telephone or Internet connected device, to provide purchase information or other feedback to the server.

IPTV includes a service that provides presenting channels, video on demand (VOD), bidirectional data service, and the like, through a user terminal, set-top box, or other device via a high-speed network, such as the Internet.

Mobile communication includes second-generation mobile communication such as Global System for Mobile Telecommunication (GSM), Code Division Multiple Access (CDMA), and the like; third-generation mobile communication such as Wideband Code Division Multiple Access (WCDMA), CDMA2000, High-Speed Downlink Packet Access (HSDPA), and High Speed Uplink Packet Access (HSUPA), and the like; and next-generation mobile communication such as Wibro, Long Term Evolution (LTE), and the like. Mobile communication also includes a medium for transmitting private content for present on a media device, such as on a relatively small interface of a mobile phone or PDA.

Internet web browser refers to a medium for transmitting documents created using a markup language or other technology, such as Hyper Text Markup Language (HTML), Extensible Markup Language (XML), and/or Standard Generalized Markup Language (SGML), using transfer protocol such as Hyper Text Transfer Protocol (HTTP) or Transmission Control Protocol/Internet Protocol (TCP/IP).

Digital Multimedia Presenting (DMB), including terrestrial DMB and satellite DMB, refers to a medium for transmitting private content designed for a relatively small interface of a portable DMB terminal.

In an embodiment, a virtual shopping mall is provided via a bulletin board, website, Usenet or other newsgroup service, among other on-line or off-line media.

In a particular embodiment, a virtual shopping mall, referred to as an Internet shopping mall, is presented via a computer or other media device connected to the Internet. Information for presenting or selling goods is transmitted to the computer or other media device via the Internet. In a further embodiment, purchase information or other feedback is transmitted from the computer or other media device to a server via the Internet.

In a particular embodiment, a virtual shopping mall, referred to as an IPTV shopping mall, is presented via IPTV. Information for presenting or selling goods is transmitted to a TV or other media device via a high-speed connection. In a further embodiment, purchase information or other feedback is transmitted by a user to a server via a set-top box, telephone, Internet connected device, or other communication device.

In a particular embodiment, a virtual shopping mall, referred to as a TV home shopping mall, is presented on a TV via TV home shopping network as further described below. In an embodiment, a set top box allows a user of the TV to provide purchase information or other feedback to a server. In an embodiment, the user uses another communication device, such as a telephone or Internet connected device, to provide purchase information or other feedback to the server.

In an embodiment, a virtual shopping mall is presented as a virtual world.

In an embodiment, a virtual shopping mall is presented via a home shopping network implemented through a presenting cable or a telephone line.

Throughout this disclosure, a goods sale contest refers to a virtual shopping mall operating scheme whereby goods are pitted against each other in a sales competition and a benefit is provided to buyers of a winning good. In an embodiment, such a goods sale contest is established by a request for the goods sale contest and an acceptance of the request. In an embodiment, the resulting good sale contest varies from the one requested. For example, different or additional goods or sellers can participate. In an embodiment, the goods sale contest is selected or established without regard to any request. The goods sale contest can include a 1:1 (one-on-one) goods sale contest or a multi-party goods sale contest involving at least three sellers. In an embodiment, additional sellers can be added to a 1:1 goods sale contest to establish a multi-party goods sale contest.

For the 1:1 goods sale contest, a sale result can be analyzed to determine a winning seller. Various benefits such as a winning bonus can be given to the winning seller and buyers purchasing the goods of the winning seller. For the multi-party goods sale contest, a sale result can be analyzed to determine a goods sale rank. Different benefits corresponding to a sale rank of the sellers can be given to the sellers and buyers purchasing the goods.

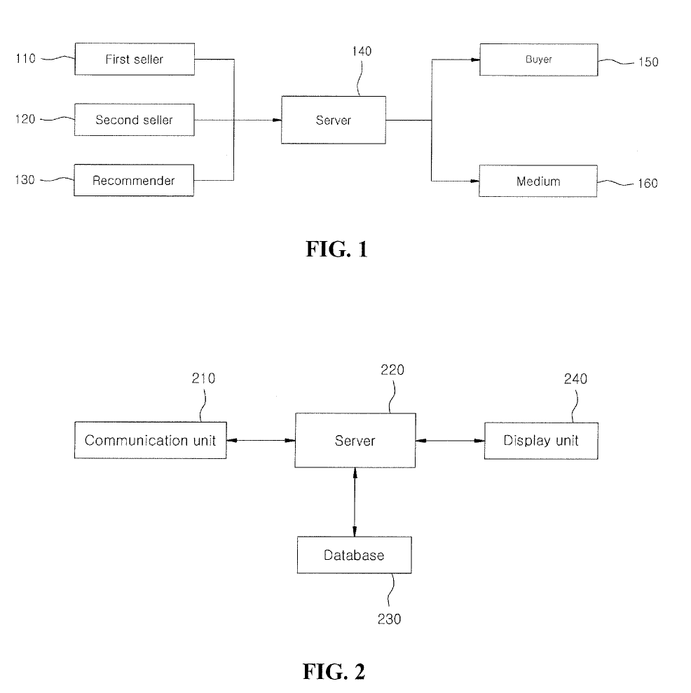

FIG. 1 is a functional block diagram of a system for providing a virtual shopping mall according to an example embodiment of the present invention. A 1:1 goods sale contest according to an example embodiment will be described and then a multi-party goods sale contest will be described.

As shown in FIG. 1, a system for providing a virtual shopping mall according to the present invention can include a first seller 110, a second seller 120, a recommender 130, a server 140, a buyer 150, and a medium 160. FIG. 1 presents an illustrative example of such a system. Other embodiments are possible with more, fewer, or different components. Or the components shown can be differently configured. As discussed above, the functions of the various components can be distributed across one or more network elements on a network.

In the embodiment shown, the first seller 110 and the second seller 120 sell goods or services in the virtual shopping mall. In an embodiment, the first seller 110 or the second seller 120 requests a sale contest to the server 140. For example, the first seller 110 requests the sale contest to the server 140. In this case, the first seller 110 can inform the server 140 of a brand name of a desired contestant or goods types for the sale contest. The server 140 can search for the contestant for the sale contest requested by the first seller 110, based on the brand name or the goods types. In this case, when the second seller 120 is searched as the contestant for the sale contest, the server 140 can propose the goods sale contest requested by the first seller 110 to the second seller 120. When the second seller 120 accepts the proposal, the first seller 110 and the second seller 120 can proceed with the goods sale contest. In an embodiment, the goods sale contest proceeds regardless of whether the second seller accepts the proposal. In an embodiment, the server 140 substitutes other goods or sellers for those requested. In an embodiment, the server 140 can search for contestants and/or goods and select and establish a goods sale contest without regard to any such request.

In an embodiment, the goods sale contest can be requested by the recommender 130. Examples of the recommender 130 can include the server 140, the buyer 150, and an ordinary customer. For example, the buyer 150 can recommend a goods sale contest between the first seller 110 and the second seller 120. The first seller 110 and the second seller 120 can be sellers who sell goods with competitive brands or goods with similar specifications. The server 140 proposes the goods sale contest to the first seller 110 and the second seller 120. When the first seller 110 and the second seller 120 accept the proposal, the server 140 proceeds with the goods sale contest. In an embodiment, the server 140 can perform a pros and cons vote for the goods sale contest recommended by the buyer 150, and determine whether to proceed with the goods sale contest based on the vote result. In an embodiment, the goods sale contest proceeds regardless of whether the first or second sellers accept the proposal. In an embodiment, the server 140 substitutes other goods or sellers for those requested. In an embodiment, the contest can further include a multi-party goods sale contest. For example, third and fourth sellers can be added for the multi-party goods sale contest.

In the embodiment shown, the server 140 can mediate the sale contest between the first seller 110 and the second seller 120. The server 140 can mediate the sale contest in real time through the medium 160. The server 140 can transmit the sale contest result to the specific medium 160 for advertisement. The specific medium 160 can include a TV home shopping network, an Internet protocol television (IPTV), Internet user created contents (UCC), a media organization's server, or other media or media device as discussed above. The specific medium can be an on-line or off-line medium.

In an embodiment, the first seller 110 proposes brands and goods of the second seller 120 to the server 140 for the sale contest and the second seller 120 accepts the proposal through the server 140 before the goods sale contest proceeds. Thus, in this case, the contestants consent to the goods sale contest before it proceeds. In an alternate embodiment, the contest proceeds without the consent of one or more of the contestants. When at least two desired companies or brands are recommended by the server 140, the buyer 150 or an ordinary customer (or a netizen), the server 140 can establish the goods sale contest through a vote, thereby allowing direct participation of the customer.

According to an embodiment of the present invention, the first seller 110 and the second seller 120 can increase advertisement earnings through the medium 160 according to the contest result. The buyer 150 can obtain information on popular goods for sale through the medium 160.

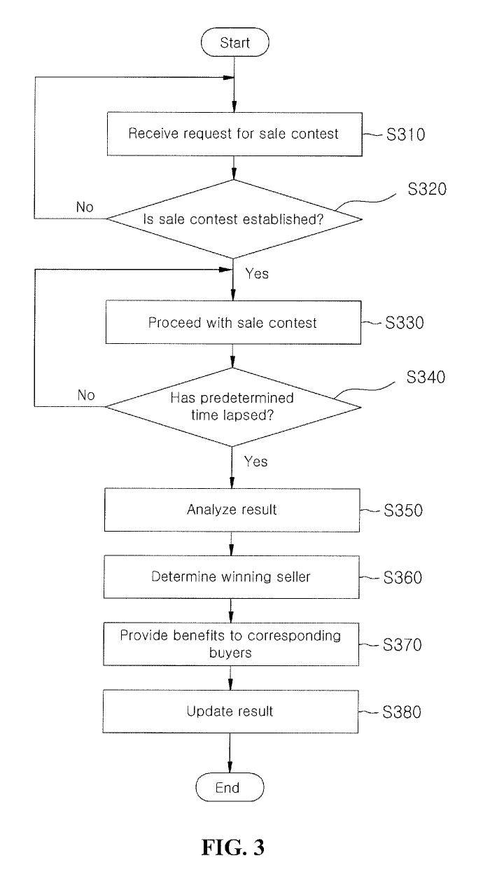

FIG. 2 is a functional block diagram of a server for providing a virtual shopping mall according to an example embodiment of the present invention, and FIG. 3 is a flowchart of a method for providing a virtual shopping mall according to an example embodiment of the present invention.

As shown in FIG. 2, a virtual shopping mall server system according to the present invention can include a communication unit 210, a controller 220, a database 230, and a display unit 240. FIG. 2 presents an illustrative example of such a server. Other embodiments are possible with more, fewer, or different components. Or the components shown can be differently configured. As discussed above, the functions of the various components can be distributed across one or more network elements on a network.

The communication unit 210 can support communication among the virtual shopping mall server, a seller, and a buyer, among other persons and components. The communication unit 210 can be automatically connected to a specific medium, such as the medium 160. In an embodiment, the specific medium advertises a goods sale contest result after the goods sale contest ends. In an embodiment, the specific medium advertises the status of the goods sale contest as the contest progresses. Other uses of the specific medium are described below.

In an embodiment, the controller 220 receives a request for a requested goods sale contest. In response to the request, a goods sale contest is established and proceeds between the seller and the buyer. In an alternate embodiment, the controller 220 selects and establishes a goods sale contest without regard to such a request. In an embodiment, the established goods sale contest varies from the requested goods sale contest. For example, different goods or sellers can be substituted for those requested. In an embodiment, after a predetermined time lapses, the controller 220 analyzes the result of the goods sale contest. In an alternate embodiment, other conditions (besides the passage of time) can cause the contest to end or the result to be analyzed. For example, on of the contestants may resign, a particular sales goal may be reached, or other predetermined condition can be meet that causes the result to be analyzed. In an embodiment, the result may be analyzed and the contest may then proceed forward. In an embodiment, the contest result can be determined according to a sale record. The sale record can include a total goods sale amount or a total goods order amount. The controller 220 can then determine a winning seller based on the analyzed contest result. The winning seller can be provided with a predetermined winning bonus. The controller 220 can control the display unit 240 to present a status of the goods sale contest. In an embodiment, the status is presented in real time. Also, the controller 220 can relay the goods sale contest status on a specific medium such as a TV home shopping network, an IPTV, or Internet UCC through the communication unit. In an embodiment, the status is relayed in real time. In an embodiment, the status is also presented in real time on the specific medium.

The database 230 can store status and/or updated contest results under control of the controller 220. Accordingly, the contest results stored in the database 230 can be used to recognize a seller's contest record and a buyer's betting ability.

The display unit 240 can present the contest status in real time under control of the controller 220. In an embodiment, the goods sale contest status can be relayed in real time through the display unit 240.

A method for providing a virtual shopping mall according to the present invention as shown in FIG. 3 will now be described with reference to the configuration of the virtual shopping mall providing server according to FIG. 2. FIG. 3 presents an illustrative example of such a method. Other embodiments are possible with more, fewer, or different steps. Or the steps shown can be differently arranged.

Referring to FIG. 3, the controller 220 of the server system for providing a virtual shopping mall receives a request for a goods sale contest (S310). The controller 220 can directly receive a request for a goods sale contest from at least two sellers, including a first seller and a second seller. Alternatively, the controller 220 can also receive a request for a goods sale contest from a recommender, such as a buyer. In another embodiment, the sale contest is established without regard to any request.

When the sale contest is established, the controller 220 controls to proceed with the sale contest (S320, S330). The controller 220 can mediate a method of sale between the sellers, buyer's purchase, payment, delivery, after-sale service, etc. The controller 220 can proceed with the goods sale contest as a 1:1 contest. The controller 220 can change the contest into a survival consecutive-victory contest or a tournament contest, in which multiple 1:1 contests are consecutively performed. The type of the sale contest can be determined by a requester upon requesting the contest. In an embodiment, the type of sale contest can be determined by the virtual shopping mall providing server. In an embodiment, the type of sale contest can be determined according to a format for the virtual shopping mall providing server provided by the controller 220. The goods contest can be established according to goods categories, such as brand, price, type, and use. The controller 220 can control the display unit 240 to present a status of the contest. In an embodiment, the status is displayed in real time. The controller 220 can control the communication unit 210 to relay the goods sale status through a specific medium, such as the medium 160, which is automatically connected to the communication unit 210. In an embodiment, the status is relayed in real time.

After a predetermined contest proceeding time lapses or other triggering event or condition is obtained, the controller 220 can analyze the contest result (S340, S350). The contest result can be determined based on a total order amount or a total sale amount.

In an embodiment, the controller 220 determines a winning seller according to the analyzed contest result and provides benefits to buyers purchasing the goods of the winning seller (S360, S370). The benefits can include mileage and reservation of reserve-funds, discounts, coupons, and the like. The controller 220 can further provide a winning bonus to the winning seller. The winning bonus can include a discounted sale commission and an advertisement priority. In this case, the contest result in the 1:1 contest or the survival consecutive-victory contest can be determined as one of a KO victory, a win on points, and a tie. The contest result in the tournament can be determined according to a victory point and a victory percentage.

In an embodiment, the controller 220 updates the contest result and bonus provision content in the database 230 (S380). The contest result and the bonus provision content updated in the database 230 can be used for contest record management.

In an embodiment, the controller 220 controls the communication unit 210 to advertise the contest result using the specific medium, such as the medium 160, automatically connected through the communication unit 210. The communication unit 210 can support communications such as high speed Internet or wireless Internet.

FIG. 4 schematically illustrates a category-specific goods sale contest according to an example embodiment of the present invention. As shown in FIG. 4, a goods sale contest according to the present invention can be classified according to categories. FIG. 4 presents illustrative examples. Other embodiments are possible with more, fewer, or different categories.

The goods sale contests according to the present invention can be classified according to categories. For example, the goods sale contests can be classified according to ideas, country brands, regions, prices, functions, and the like. The goods sale category can be determined according to request content written by a requester upon requesting the goods sale contest. The goods sale category can be determined by a basic format for the server system for providing a virtual shopping mall.

In an embodiment, third and fourth (or more) sellers can be added for a multi-party goods sale contest, in addition to the first and second sellers proceeding with the 1:1 goods sale contest. In an embodiment, after the multi-party goods sale contest has proceeded for a predetermined time or another triggering event or condition is obtained, the controller 220 can analyze the goods sale result to determine a sale rank of the plurality of sellers proceeding with the multi-party goods sale contest. The controller 220 can control the display unit 240 to display to the sale rank. The controller 220 can control the communication unit 240 to transmit the sale rank to a medium, such as a medium 160 for presentation. In an embodiment, the controller 220 provides different benefits to buyers purchasing goods of the plurality of sellers according to the sale rank of the plurality of sellers.

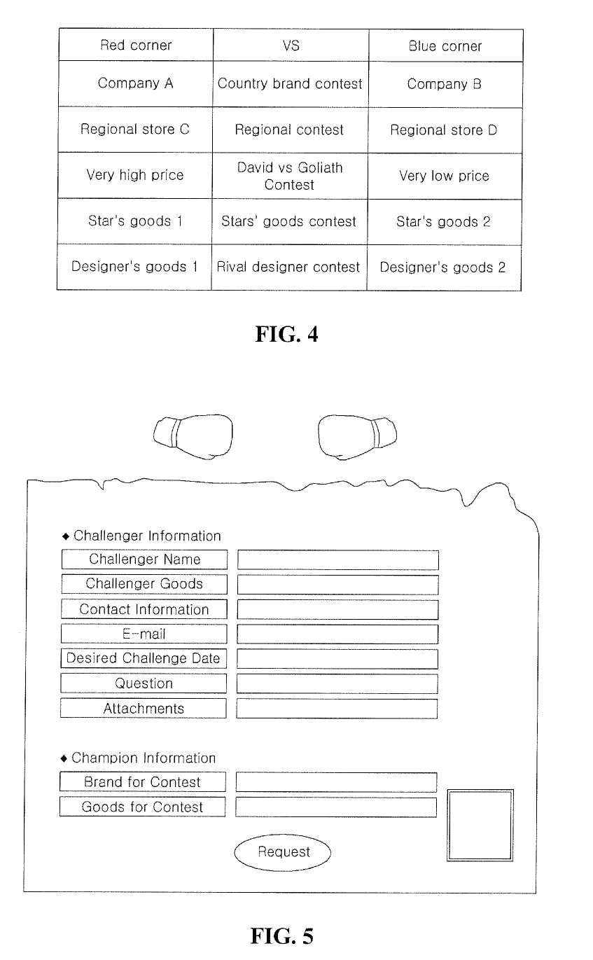

FIG. 5 illustrates an interface for a requesting a goods sale contest in the form of a written challenge according to an example embodiment of the present invention. FIG. 5 presents an illustrative example of such an interface. Other embodiments are possible with more, fewer, or different components. Or the components shown can be differently arranged or configured.

In the embodiment shown in FIG. 5, a goods sale contest according to the present invention can be requested directly by a seller. The seller can request a goods sale contest through a request in the form of a written challenge. For example, the seller writes the request for a goods sale contest in the form of a written challenge, in which a first seller desiring to sell goods writes his or her name, goods name, contact information, and the like to the written challenge. The first seller further writes goods of desired brands or categories for the goods sale contest. The information shown in FIG. 5 is merely illustrative. More, less, or different information can be received, stored, or transmitted as part of a written challenge. A virtual shopping mall providing server managing and mediating the goods sale contest can then search for goods corresponding to the brands or categories for the contest and propose a goods sale contest to a second seller selling the searched goods. In an embodiment, the goods sale contest proposed can vary the goods sale contest requested as discussed above. In an embodiment, the second seller accepts the proposal before the goods sale contest can be established. In other example embodiments, when the first seller writes only his or her name, goods name, and contact information to the written challenge, the virtual shopping mall providing server can directly analyze a category and a brand based on the goods name of the first seller to search for the second seller.

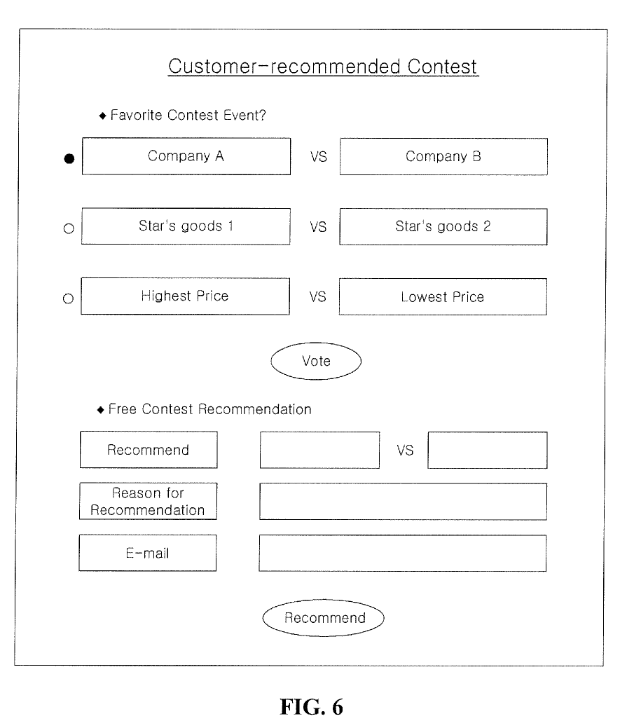

FIG. 6 illustrates an interface for requesting a goods sale contest by a recommender according to an example embodiment of the present invention. FIG. 6 presents an illustrative example of such an interface. Other embodiments are possible with more, fewer, or different components. Or the components shown can be differently arranged or configured.

As shown in FIG. 6, a goods sale contest according to the present invention can be requested by a recommender. The recommender can be a first seller desiring the goods sale contest. Alternatively, the recommender can be a virtual shopping mall providing server or a customer (such as a buyer and an ordinary customer). For example, the virtual shopping mall providing server can hold a vote for a method of a goods sale contest. The goods sale contest can proceed in the method for the goods sale contest determined by the vote. In an embodiment, the method for the goods sale contest can include a brand contest, a stars' goods contest or a product-specific contest. In an embodiment, the virtual shopping mall providing server can receive a goods sale contest recommendation from the recommender in real time. In an embodiment, the virtual shopping mall providing server can receive a request for a sale contest for a plurality of goods from the customer. The information shown in FIG. 6 is merely illustrative. More, less, or different information can be received, stored, or transmitted as part of a recommendation.

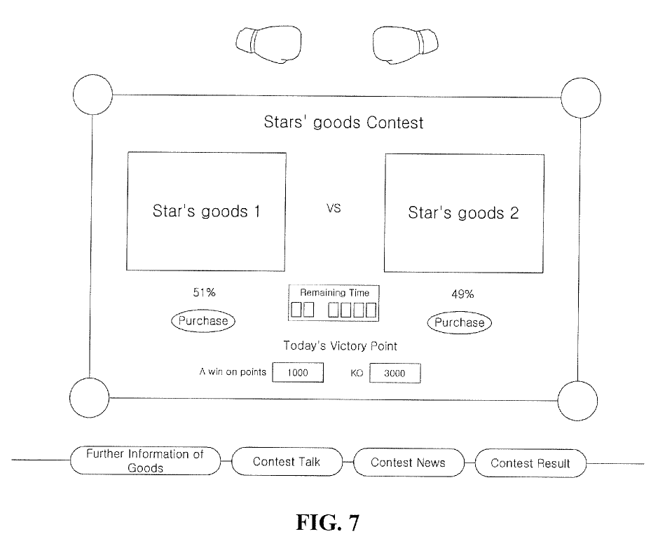

FIG. 7 illustrates an interface for providing a 1:1 goods sale contest according to an example embodiment of the present invention. FIG. 7 presents an illustrative example of such an interface. Other embodiments are possible with more, fewer, or different components. Or the components shown can be differently arranged or configured.

As shown in FIG. 7, a goods sale contest can be performed as a 1:1 contest. The 1:1 goods sale contest can be established according to categories of goods. A result of the 1:1 goods sale contest can include a win on points, a KO victory by early sell-out, or a tie. The contest result can be determined according to a total order amount or a total sale amount. The contest result can be determined as the win on points for different total order amounts or different total sale amounts, the KO victory for early sell-out, or the tie for the same order amounts or the same total sale amounts.

In an embodiment of the present invention, the winning seller in the 1:1 goods sale contest can be provided with a winning bonus. The winning bonus can include discounted sale commission and an advertisement priority. For example, a different rate of reservation of reserve-funds or a different commission discount rate can be applied according to the contest result. For example, the rate can be 1% of price on the average for the win on points and 3% for the KO victory. A penalty can be given to a KO-defeated seller to prevent the seller from participating in the contest during a specific period. These bonuses are merely illustrative. Other bonuses can be used with the subject invention.

Benefits can be given to buyers purchasing the goods of the winning seller, as well as the winning seller. In an embodiment, the benefits can include mileage and reservation of reserve-funds, discounts, and coupons. These benefits are merely illustrative. Other benefits can be used with the subject invention.

In an embodiment, the 1:1 contest can be performed several times to determine a final winning seller weekly or monthly. The final winning seller can be provided with a predetermined additional bonus. In this case, the final winning seller can be determined by a consecutive-victory contest. The consecutive-victory contest can include a tournament contest, a survival consecutive-victory contest, and the like. The consecutive victory contest can further include a consolation game and a return game.

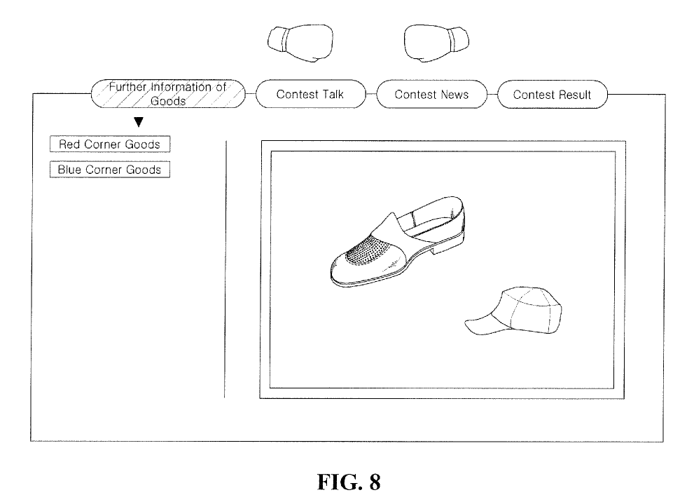

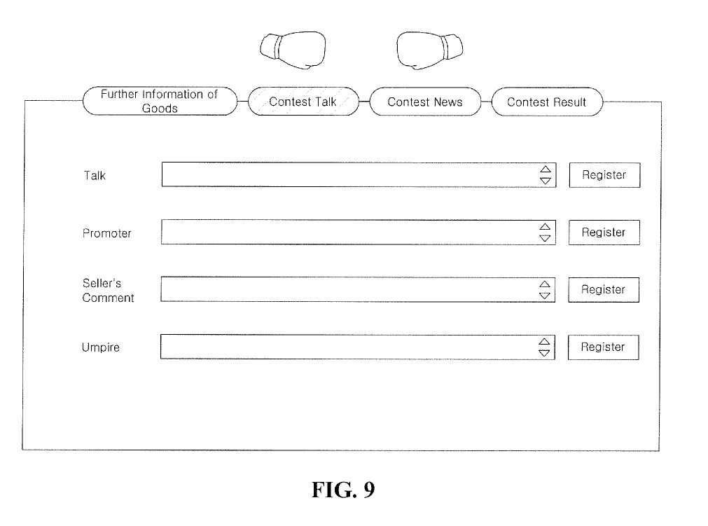

FIG. 8 illustrates an interface for presenting further information of goods for sale according to an example embodiment of the present invention. FIG. 8 presents an illustrative example of such an interface. Other embodiments are possible with more, fewer, or different components. Or the components shown can be differently arranged or configured.

As shown in FIG. 8, further information of goods for sale can be provided by clicking on a control, such as an icon or button. For example, in case of a 1:1 goods sale contest, further information of goods of a first seller is presented on clicking on a button “Red Corner Goods.” Further information of goods of a second seller is presented on clicking on a button “Blue Corner Goods.” The controls can be substituted or modified according to the format requirements of the specific virtual shopping mall providing server and medium used. Thus, buyers desiring to purchase goods through the virtual shopping mall providing server can view further information of products by simply clicking on the buttons.

FIG. 9 illustrates an interface for providing a community in which goods sale information is exchanged according to an example embodiment of the present invention. FIG. 9 presents an illustrative example of such an interface. Other embodiments are possible with more, fewer, or different components. Or the components shown can be differently arranged or configured.

As shown in FIG. 9, a community interface according to the present invention enables a seller and a buyer to exchange goods sale information. For example, the community can include a bulletin board that enables buyers to write questions about goods sale or an additional request. The bulletin board can have a function for comments. The community can further include controls for a moderator that enables the moderator to moderate such communications. For example, the moderate can remove spurious content, profanity, false information, or antagonistic content, among other undesirable content. In an embodiment, the moderator may warn a user who posted such content. Thus, the community interface enables the seller and the buyer to smoothly exchange opinions and perform goods sale. Also, mediation by the moderator enables a fair goods sale contest.

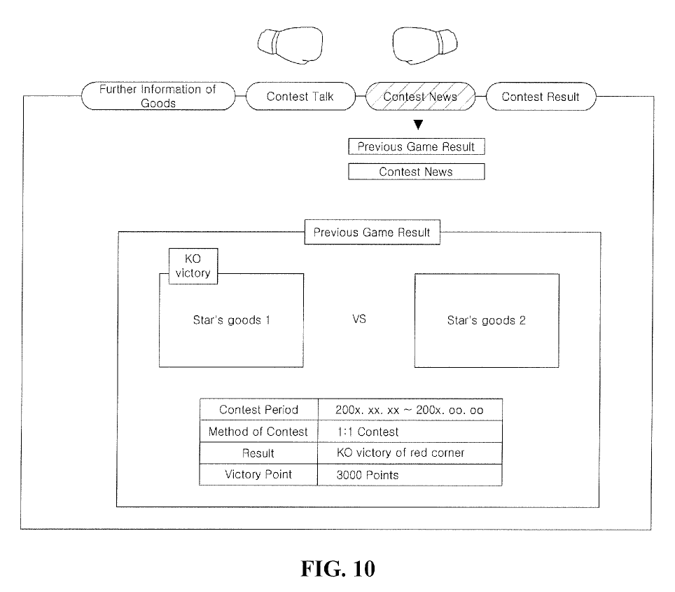

FIG. 10 illustrates an interface for presenting a result of a goods sale contest according to an example embodiment of the present invention. FIG. 10 presents an illustrative example of such an interface. Other embodiments are possible with more, fewer, or different components. Or the components shown can be differently arranged or configured.

As shown in FIG. 10, a result of a goods sale contest according to the present invention can be indicated on a screen. The result can include victory or defeat, contest record, contest record management, and the like. In an embodiment, the customer can refer to results of previous goods sale contests any time he or she likes. The information shown in FIG. 10 is merely illustrative. More, less, or different information can be received, stored, or transmitted as part of a contest result.

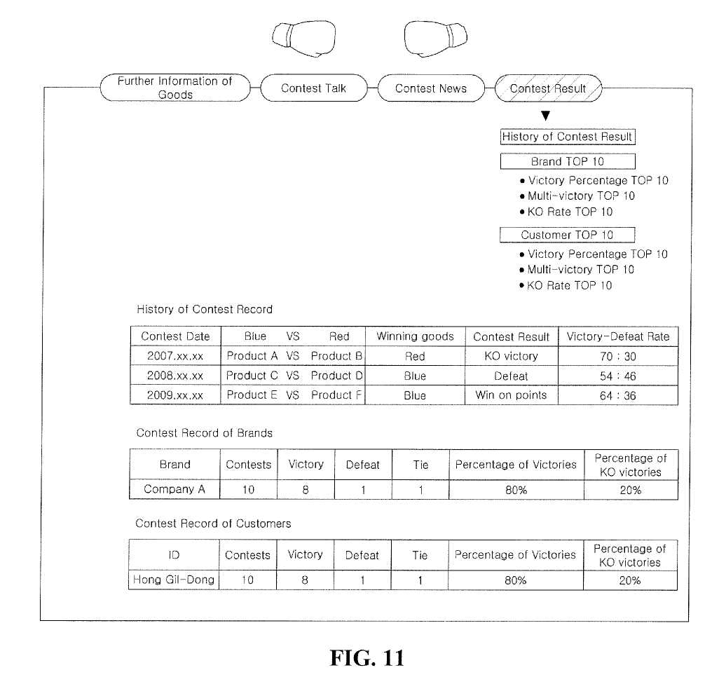

FIG. 11 illustrates an interface for managing a contest record of one or more goods sale contests according to an example embodiment of the present invention. FIG. 11 presents an illustrative example of such an interface. Other embodiments are possible with more, fewer, or different components. Or the components shown can be differently arranged or configured.

As shown in FIG. 11, a contest record of a goods sale contest according to the present invention can be managed according to customers, brands, dates, and categories. As shown, various information can be received, stored, organized, analyzed, transmitted, and presented via such an interface. The contest record management can include goods sale contest results and bonus provision content. A priority can be given to each seller based on the contest record. For example, the contest record management can be used to determine a rank according to multi-victory, KO, and a victory percentage, and benefits such as an advertisement priority and a discounted commission can be given according to the determined rank. The information shown in FIG. 11 is merely illustrative. More, less, or different information can be received, stored, or transmitted as part of a contest record.

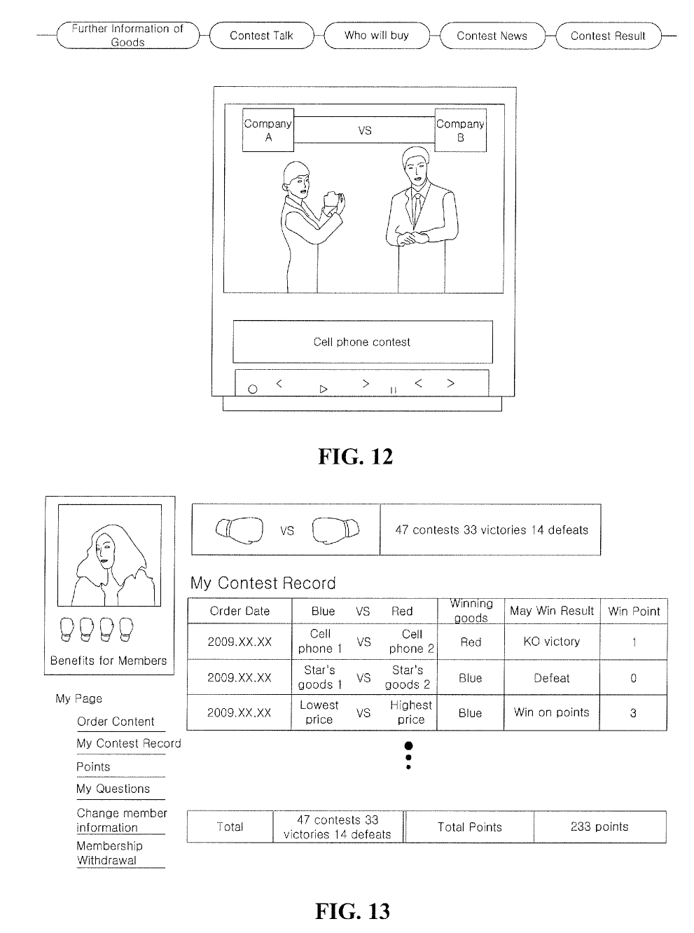

FIG. 12 illustrates an interface for presenting a goods sale contest according to an example embodiment of the present invention. In an embodiment, the goods sale contest is presented live in real time. FIG. 12 presents an illustrative example of such an interface. Other embodiments are possible with more, fewer, or different components. Or the components shown can be differently arranged or configured.

As shown in FIG. 12, a status of the goods sale contest according to the present invention can be relayed through a specific medium, such as the medium 160. In an embodiment, the status can be relayed in real time. This enables the seller and the buyer to recognize and participate in the goods sale contest in real time through a TV, the Internet, or other medium. Also, the goods sale contest result can be advertised through the medium to maximize advertisement effects. The information shown in FIG. 12 is merely illustrative. More, less, or different information can be received, stored, or transmitted as part of a contest status.

FIG. 13 illustrates an interface for managing a contest record for a particular person according to an example embodiment of the present invention. FIG. 13 presents an illustrative example of such an interface. Other embodiments are possible with more, fewer, or different components. Or the components shown can be differently arranged or configured.

As shown in FIG. 13, the interface for contest record management according to the present invention can be provided for a particular person. In an embodiment, the interface enables a seller or a buyer to confirm or edit his or her contest record by logging in to a corresponding webpage with his or her ID. In an embodiment, the contest record can be provided according to a sale date or order date. In an embodiment, the contest record can be provided via a webpage or other medium. The information shown in FIG. 13 is merely illustrative. More, less, or different information can be received, stored, or transmitted as part of a personal contest record.

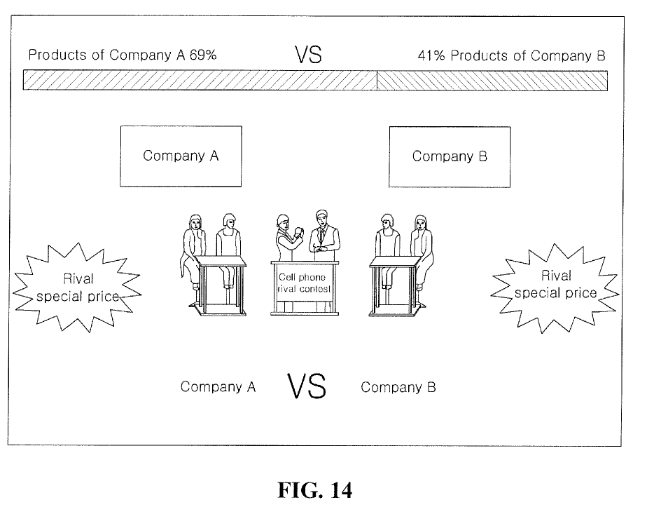

FIG. 14 illustrates an interface for presenting of a 1:1 goods sale contest via a TV home shopping network according to an example embodiment of the present invention. FIG. 14 presents an illustrative example of such an interface. Other embodiments are possible with more, fewer, or different components. Or the components shown can be differently arranged or configured.

As shown in FIG. 14, a goods sale contest through a TV home shopping network can be implemented as a 1:1 contest. In an embodiment, the TV home shopping network can proceed live. A contest proceeding time can vary with cooperation with a home shopping company. The information shown in FIG. 14 is merely illustrative. More, less, or different information can be received, stored, or transmitted as part of such a presentation.

In an embodiment, the goods sale contest can be requested by sellers. For example, a first seller can propose the sale contest to a home shopping manager for brands or goods of a second seller when requesting the contest. The home shopping manager can then delivers the proposal to the second seller. When the second seller accepts the proposal, the 1:1 goods sale contest can proceed. In an embodiment, the goods sale contest is proceeds without the consent of the second seller.

In an embodiment, the 1:1 goods sale contest can be requested by the home shopping manager or the buyer (including a viewer). For example, the home shopping manager or the buyer can recommend the goods sale contest for two brands or goods. The home shopping manager proposes the contest to sellers of the recommended brands or goods. When the sellers accept the proposal, the goods sale contest can proceed. In an embodiment, the goods sale contest is proceeds without the consent of the sellers.

The goods sale contest implemented through the TV home shopping network can be implemented as a survival consecutive-victory contest and a tournament contest by consecutively proceeding with a 1:1 sale contest. A contest result can be determined according to a total order amount or a total sale amount. For example, the contest result can be determined as a win on points for different total sale amounts, a KO victory for early sell-out, and a tie for the same total order amounts or total sale amounts. The contest can further include a consolation contest and a return contest.

Benefits can then be given to buyers purchasing goods of the winning seller in the 1:1 goods sale contest. The benefits can include mileage and reservation of reserve-funds, discounts, and coupons, or other benefits. In addition, the winning seller can be provided with a winning bonus. The winning bonus can include a discounted sale commission and an advertisement priority, or other bonuses. A rate of reserving reserve-funds for the buyer and a commission discount rate for the seller can be differently applied according to the contest result.

In an embodiment, for a goods sale contest held via a TV home shopping network, a show host can proceed with and mediate the goods sale contest. In an embodiment, one or more of the sellers participates as a guest to provide details of products for sale in the home shopping network.

Thus, a goods sale contest held via a TV home shopping network enables buyers to recognize goods information and a status of the goods sale contest and to participate in the contest.

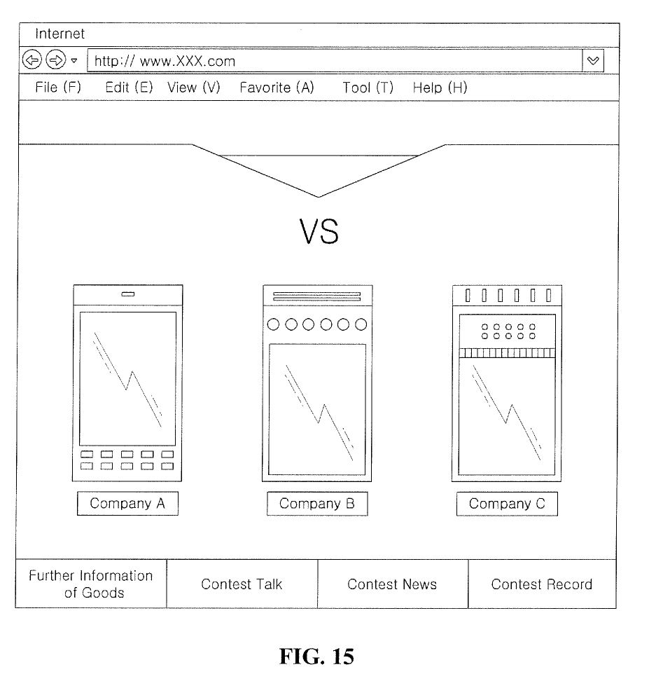

FIG. 15 illustrates an interface for presenting of a multi-party goods sale contest via an Internet shopping service according to an example embodiment of the present invention. FIG. 15 presents an illustrative example of such an interface. Other embodiments are possible with more, fewer, or different components. Or the components shown can be differently arranged or configured.

As shown in FIG. 15, a multi-party goods sale contest according to the present invention can be implemented through an Internet shopping service, such as a website. The information shown in FIG. 15 is merely illustrative. More, less, or different information can be received, stored, or transmitted as part of such a presentation.

In the embodiment shown, a multi-party goods sale contest is established including a plurality of sellers.

In an embodiment, after a predetermined sale time lapses, the sales record is analyzed to determine a contest result. In an embodiment, another trigger event or condition leads to such an analysis. In an embodiment, the analysis is performed by a mediator. In an embodiment, the mediator is a server, such as the server shown in FIG. 2. For example, the mediator can be a server for managing IPTV broadcasting. In another embodiment, the mediator can be a separate show host who proceeds with the multi-party goods sale contest broadcasted through an IPTV.

In an embodiment, the mediator determines a sale rank of the plurality of sellers, based on the analyzed sales record. The sale rank of the sellers can be determined based on a total order amount or a total sale amount, among other methods.

In an embodiment, the mediator can then give different benefits to buyers purchasing the goods of the plurality of sellers according to the sale rank. The benefits can include mileage and reservation of reserve-funds, discounts, and coupons, among other benefits. In addition, the mediator can give a predetermined winning bonus corresponding to the rank to the plurality of sellers. The winning bonus can include benefits such as a discounted sale commission and an advertisement priority, among other benefits. For example, the mediator can give the benefits such as a discounted sale commission and an advertisement priority to high ranked sellers according to the rank. On the other hand, the mediator can give penalties such as sale restriction during a predetermined period or a relatively higher commission rate to low ranked sellers.

In other example embodiments of the present invention, the multi-party sale contest can be implemented by a wired/wireless Internet shopping service, an IPTV shopping service, or a TV home shopping network. In an embodiment, the wireless Internet shopping service can be implemented through mobile devices, such as cell phones, personal digital assistants (PDAs), smart phones, and Net-books, among other mobile media devices.

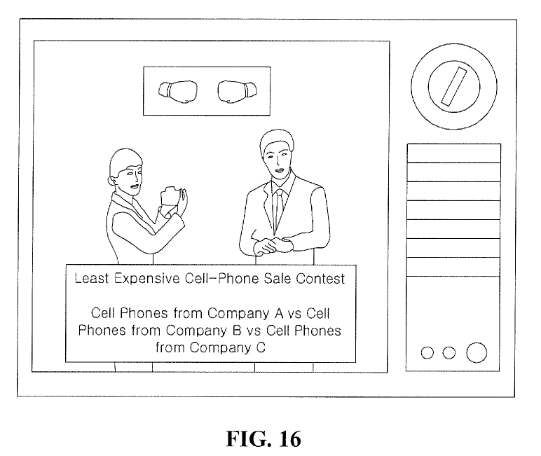

FIG. 16 illustrates an interface for presenting of a multi-party goods sale contest via a TV home shopping network according to an example embodiment of the present invention. FIG. 16 presents an illustrative example of such an interface. Other embodiments are possible with more, fewer, or different components. Or the components shown can be differently arranged or configured.

As shown in FIG. 16, a multi-party goods sale contest can be implemented through a TV home shopping network. In an embodiment, the multi-party goods sale contest can be presented live. Details of the multi-party goods sale contest can vary with cooperation with a TV home shopping company. The information shown in FIG. 16 is merely illustrative. More, less, or different information can be received, stored, or transmitted as part of such a presentation.

In an embodiment, the multi-party goods sale contest is established in response to a request for a contest. In an embodiment, the multi-party goods sale contest is requested by at least one of the plurality of sellers. For example, when there are six sellers, a first seller can identify five goods sellers or five brands in a multi-party goods sale contest request. In an embodiment, such a request is submitted to a server, such as the server 140, as discussed above. In an embodiment, such a request is submitted to a home shopping manager. In an embodiment, the server or home shopping manager can then deliver the request for a goods sale contest to the other five sellers for approval. In an embodiment, the five sellers accept the request for a goods sale contest before the multi-party goods sale contest can proceed. In another embodiment, the contest proceeds without the approval or one or more of the sellers.

As discussed above, the contest established can differ from the contest requested. For example, in an embodiment, a server, such as the server 140, can identify a substitute seller to replace a seller that does not consent to the contest. In another embodiment, a seller requests a 1:1 contest, but a server establishes a multi-goods sale contest by adding sellers to the requested contest.

In another embodiment, the multi-party goods sale contest can be requested by a home shopping manager or a buyer (including a viewer). For example, the home shopping manager or the buyer can recommend a goods sale contest for several brands or goods. In an embodiment, the home shopping manager can then propose the multi-party goods sale contest to sellers of the recommended brand or goods. In an embodiment, the sellers accept the proposal before the multi-party goods sale contest can proceed. In another embodiment, the contest proceeds without the approval or one or more of the sellers. In an embodiment, the contest is established without regard to any request.

In an embodiment, when the multi-party goods sale contest proceeds and a predetermined time lapses, the sales record is analyzed to determine a contest result. In an embodiment, another trigger event or condition leads to such an analysis as discussed above. In an embodiment, the analysis is performed by a mediator. In an embodiment, the mediator can analyze the sales record in consideration of sale amounts of the respective sellers. In an embodiment, the mediator is a server, such as the server shown in FIG. 2. In an embodiment, the mediator is a person, such as home shopping manager or a separate show host proceeding with the multi-party goods sale contest through the TV home shopping network, or such another person.

In an embodiment, the mediator can determine a sale rank of the plurality of sellers based on the analyzed sales record. In an embodiment, the sale rank of the sellers is determined based on a total order amount or a total sale amount, among other methods.

Different benefits can be given to buyers purchasing the goods of the plurality of sellers according to the sale rank. The benefits can include mileage and reservation of reserve-funds, discounts, and coupons, among other benefits. In addition, a predetermined winning bonus corresponding to the sale rank can be given to the plurality of sellers. The winning bonus can include benefits such as a discounted sale commission and an advertisement priority, among other benefits. In an embodiment, penalties such as sale restriction during a predetermined period or a relatively higher commission rate can be given to low ranked order sellers.

The above-described methods, systems, and interfaces can be implemented as computer-readable code in one or more computer-readable media. As is known in the art, data and instructions can be stored in a single computer-readable medium or distributed amongst multiple computer-readable media.

The systems and methods of the present invention are not limited to the configurations and methods of the above-described embodiments. All or some of the embodiments can be selectively combined to form variants of the embodiments. Many different arrangements of the various components depicted, as well as components not shown, are possible without departing from the spirit and scope of the present invention. Embodiments of the present invention have been described with the intent to be illustrative rather than restrictive. A skilled artisan can develop alternative means of implementing the aforementioned improvements without departing from the scope of the present invention. It will be understood that certain features and subcombinations are of utility and can be employed without reference to other features and subcombinations and are contemplated within the scope of the claims. Not all steps listed in the various figures need be carried out in the specific order described.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for providing a virtual shopping mall, comprising:
receiving a request for a goods sale contest;
analyzing a contest result in consideration of a sale record after a predetermined time lapses when the goods sale contest is established and proceeds in response to the request;
determining a winning seller based on the analyzed contest result; and
giving benefits to buyers purchasing goods of the winning seller.

2. The method of claim 1, wherein the goods sale contest is at least one of a 1:1 contest and a multi-party contest.

3. The method of claim 2, further comprising: for the multi-party contest,
determining a sale rank of a plurality of sellers in consideration of the sale record; and
giving different benefits to buyers purchasing goods of the plurality of sellers according to the determined sale rank.

4. The method of claim 1, wherein the benefits comprise at least one of mileage and reservation of reserve-funds, discounts, and coupons.

5. The method of claim 1, further comprising:
giving a predetermined winning bonus to the determined winning seller.

6. The method of claim 5, wherein the winning bonus comprises at least one of a discounted sale commission and an advertisement priority.

7. The method of claim 1, further comprising:
advertising the contest result through an automatically connected specific medium.

8. The method of claim 7, wherein the specific medium comprises at least one of a television (TV) home shopping network, an Internet protocol television (IPTV), Internet user created contents (UCC), and a media organization's server.

9. The method of claim 1, further comprising:
updating the contest result in a separate database.

10. The method of claim 1, wherein the virtual shopping mall comprises at least one of a wired/wireless Internet shopping mall, an IPTV shopping mall, and a TV home shopping mall.

11. A system for providing a virtual shopping mall, comprising:
a controller for receiving a request for a goods sale contest, analyzing a contest result in consideration of a sale record after a predetermined time lapses when the goods sale contest is established and proceeds in response to the request, determining a winning seller based on the contest result, and giving benefits to buyers purchasing goods of the winning seller; and
a present unit for presenting a status of the goods sale contest in real time.

12. The system of claim 11, wherein the goods sale contest is at least one of a 1:1 contest and a multi-party contest.

13. The system of claim 12, wherein for the multi-party contest, the controller determines a sale rank of a plurality of sellers in consideration of the sale record, and gives different benefits to buyers purchasing goods of the plurality of sellers according to the sale rank.

14. The system of claim 11, wherein the controller gives the benefits including at least one of mileage and reservation of reserve-funds, discounts, and coupons to the buyers.

15. The system of claim 11, wherein the controller gives a predetermined winning bonus to the determined winning seller.

16. The system of claim 15, wherein the controller gives the winning bonus including at least one of a discounted sale commission and an advertisement priority to the winning seller.

17. The system of claim 11, further comprising a communication unit automatically connected to a specific medium to advertise the contest result under control of the controller.

18. The system of claim 17, wherein the specific medium comprises at least one of a TV home shopping network, an IPTV, Internet UCC and a media organization's server.

19. The system of claim 11, further comprising:
a database for updating the contest result under control of the controller.

20. The system of claim 11, wherein the virtual shopping mall is at least one of a wired/wireless Internet shopping mall, an IPTV shopping mall, and a TV home shopping mall.
